(19) United States
(12) Patent Application Publication
(10) Pub. No.: US 2026/0138420 A1
(43) Pub. Date: May 21, 2026

(54) Method of Operating a Cooling Unit and Cooling Unit

(71) Applicant: MAHLE International GmbH, Stuttgart (DE)

(72) Inventors: Daniel Schleicher, Esslingen am Neckar (DE); Jorge Curras Guede, Ostfildern (DE); Uli Christan Blessing, Donnbronn (DE); Anja Kies, Weil der Stadt (DE); Thorsten Möllert, Stuttgart (DE)

(21) Appl. No.: 19/393,748

(22) Filed: Nov. 19, 2025

(30) Foreign Application Priority Data
Nov. 20, 2024 (DE) 102024134113.0

(51) Int. Cl. B60H 1/32; B60H 1/00

(52) U.S. Cl. CPC B60H 1/3217; B60H 1/00385; B60H 1/00485; B60H 1/3225

(57) ABSTRACT

A method for operating a cooling unit that contains a slightly inflammable refrigerant is provided. The method is used with refrigerant circuit containing the slightly inflammable refrigerant and at least two shut-off devices that can be controlled by a computer, in which the computer closes the at least two shut-off devices thus dividing the refrigerant circuit into at least two separate segments when the cooling unit is switched off.

### CROSS-REFERENCE TO RELATED APPLICATIONS

This application claims priority from German Patent Application No. DE 10 2024 134 113.0, filed on Nov. 20, 2024, the entirety of which is hereby incorporated by reference herein.

The present invention relates to a method for operating a cooling unit containing a slightly inflammable refrigerant. The invention also relates to a cooling unit with a refrigerant circuit and a slightly inflammable refrigerant flowing therein, and with at least two shut-off devices as well as a computer for executing this method. The invention also relates to an air conditioner that contains such a cooling unit and a motor vehicle that has such an air conditioner.

Nearly all new motor vehicles have air conditioners, which are usually operated with refrigerants that contain PFAS. These include the refrigerants R134a and R1234y. PFAS are aliphatic organic compounds that are not only persistent, but also accumulate in the environment, resulting in a not insubstantial hazard for humans and the environment. Consequently, refrigerants containing these PFAS are to be used increasingly less and replaced by other refrigerants such as R744 (CO₂) or R290 (propane), neither of which contain PFAS. R290 is an optimal refrigerant for automotive air conditioners and heat pumps due to its excellent thermodynamic properties.

A disadvantage with R290 however, is that propane gas has a comparatively low flammability limit and therefore poses a significantly higher risk than other refrigerants. It is therefore planned to take different criticality levels into account in case refrigerants containing R290 escape refrigerant circuits in motor vehicles into the environment.

When these refrigerants, which are slightly inflammable and contain R290, are released in closed garages with poor ventilation, it is particularly dangerous, because even a small amount of refrigerant containing R290 in the air in the garage can exceed the lowest flammability limit.

Heat pumps used for heating that are operated with a slightly inflammable refrigerant that contains R290 and are located in poorly ventilated basements are just as dangerous.

The present invention therefore addresses the problem of developing a method for operating a cooling unit that uses a slightly inflammable refrigerant with which the disadvantages from the prior art can at least be reduced.

This problem is solved with the invention by the subject matter of the Numbered Paragraph 1. Advantageous embodiments are the subject matter of the dependent Numbered Paragraphs.

The present invention is based on the general idea of using shut-off devices already present in a refrigerant circuit for a cooling unit, e.g. magnetic valves and/or expansion valves, to divide the refrigerant circuit into at least two chambers when the cooling unit is switched off, thus significantly reducing the amount of slightly inflammable refrigerant that can escape in the case of a leak. With the method obtained with the invention for operating a cooling unit that contains a slightly inflammable refrigerant, which has a refrigerant circuit containing the slightly inflammable refrigerant and at least two shut-off devices that can be controlled by a computer, the computer closes at least two shut-off devices when the cooling unit is switched off, thus dividing the refrigerant circuit into at least two separate segments. If these refrigerant circuit segments are the same size, the amount of refrigerant that can leak out is already halved by the method obtained with the invention. Further reduction of the potential leakage can be obtained by closing all of the shut-off devices or valves in the refrigerant circuit, e.g. all of the expansion valves and magnetic valves, when the cooling unit is switched off by the computer, further segmenting, and thus reducing the volume of the individual refrigerant circuit segments, and therefore also the amount of refrigerant contained therein. To execute the method, a program in the computer can issue a command to close at least two shut-off devices in the refrigerant circuit when the cooling unit is switched off. By dividing the refrigerant circuit into at least two segments the danger of igniting any escaping refrigerant can be significantly reduced, thus reducing the danger of starting a fire in a poorly ventilated garage containing motor vehicles that have such cooling units.

The potential for starting a fire with a heat pump containing the cooling unit obtained with the invention can also be reduced in the same manner, since heat pumps in poorly ventilated basements also pose the same risk when slightly inflammable refrigerants such as R290 (propane) are used. Consequently, the potential for starting a fire can be substantially reduced by the method obtained with the invention, regardless of what the cooling unit is being used for.

In an advantageous version of the method obtained with the invention there are at least three shut-off devices in the refrigerant circuit, at least one of which is an expansion valve or a magnetic valve, and the computer closes these shut-off devices when the cooling unit is switched off. The refrigerant circuit can contain a high pressure section and a low pressure section, in which at least one of the shut-off devices is an expansion valve or magnetic valve, wherein the computer closes at least three shut-off devices, thus separating the high pressure section from the low pressure section when the cooling unit is switched off. With modern thermal management modules that contain cooling units, ca. 60-70% of the refrigerant is sent to the high pressure section, which contains a condenser, a dehumidifier, an expansion valve, or a heat exchanger, while ca. 40-30% of the refrigerant is sent to the low pressure section, which also contains at least one expansion valve and a chiller/cooler. The heat exchanger can also be connected to both the high pressure section and the low pressure section. Consequently, the high pressure section can be separated from the low pressure section when the cooling unit is switched off, thus dividing the refrigerant present in the refrigerant circuit. If there is a leak in the high pressure section, only 60-70% of the refrigerant can escape into the environment, and if there is a leak in the low pressure section, only ca. 30-40% of the refrigerant can escape, and therefore significantly less than if the refrigerant circuit were to remain undivided.

The present invention is also based on the general idea of obtaining a cooling unit that has a refrigerant circuit with a slightly inflammable refrigerant flowing therein and at least two shut-off devices that can be controlled by a computer, which is connected to the at least two shut-off devices and can also execute the method obtained with the invention described above. This cooling unit therefore significantly reduces fire hazards because the computer divides the refrigerant circuit into at least two separate refrigerant segments (chambers) when the cooling unit is switched off, such that significantly less inflammable refrigerant can escape in the event of a leak, thus lowering the potential fire hazard.

In an advantageous design of the cooling unit obtained with the invention there is a compressor in the refrigerant circuit, a shut-off device in the form of a magnetic valve downstream thereof, a condenser downstream of the magnetic valve, a dehumidifier downstream of the condenser, which can also be in the low pressure section in some embodiments, a shut-off device downstream of the dehumidifier in the form of a first expansion valve, and a heat exchanger between the first expansion valve and the compressor. There is a first branch between the dehumidifier and the first expansion valve, which is connected to the input end of the compressor through the heat exchanger and a second shut-off device downstream of the heat exchanger in the form of a second expansion valve, and a chiller downstream of the second expansion valve. Consequently, when the first expansion valve is closed, the refrigerant flows through the first branch and the heat exchanger to the second expansion valve and the chiller, and when the first expansion valve is open, at least part of the refrigerant flows through the heat exchanger directly to the compressor. If the first expansion valve is partially open, a first portion of the refrigerant, at a high pressure, flows through the first branch to the heat exchanger and the second expansion valve, and subsequently through the chiller to the compressor, and a second portion flows through the first expansion valve and the heat exchanger directly to the compressor. As a result, different pressure levels can be sent to the compressor.

In an advantageous design of the cooling unit obtained with the invention, the computer is designed to close the first expansion valve, second expansion valve and magnetic valve when the cooling unit is switched off. The aforementioned valves are examples of shut-off devices. The refrigerant circuit can be divided into two separate refrigerant circuit segments by this means, such that the amount of refrigerant that can leak out of one of these segments is further reduced, thus further lowering the potential fire hazard.

In a particularly preferred design of the cooling unit obtained with the invention, there is a second branch between the compressor (at the output end) and the magnetic valve, which is connected to the input end of the compressor by a third expansion valve. This enables a high pressurization of the refrigerant.

In a particularly advantageous design of the cooling unit obtained with the invention, the computer is designed to close the shut-off devices, in particular the first expansion valve, second expansion valve, third expansion valve, and magnetic valve, when the cooling unit is switched off. The refrigerant circuit can therefore be divided into a total of two refrigerant segments by the three expansion valves and the magnetic valve when these shut-off devices are closed, such that the amount of refrigerant escaping the refrigerant circuit, or a segment thereof, in the case of a leak, and the associated fire hazard, can be further reduced.

There can also be other shut-off devices elsewhere in the refrigerant circuit to divide it into further segments.

Ideally, the refrigerant is R290 (propane). The major advantage with using R290 as the refrigerant is its extremely low potential for contributing to global warming, making it more sustainable and environmentally friendly than other refrigerants. The fact that it also contains no chlorine or fluorine means that it also has less of an impact on the ozone layer.

The present invention is also based on the general concept of equipping an air conditioner with the cooling unit described above, such that the advantages of the cooling unit also apply to the air conditioner obtained with the invention. These advantages involve dividing the refrigerant circuit into different and smaller segments when the air conditioner is switched off, substantially reducing the fire hazard, because the amount of slightly inflammable refrigerant that can leak out of the individual refrigerant circuit segments is much less than the overall amount of refrigerant.

These advantages can also be obtained with a motor vehicle equipped with the air conditioner obtained with the invention.

This motor vehicle can be an electric vehicle. An electric vehicle is also much more environmentally friendly.

Other important features and advantages of the invention can be derived from the dependent Numbered Paragraphs, the drawing, and the descriptions of the drawing.

The features specified above and explained below can be used not only in the given combinations, but also in other combinations or in and of themselves without abandoning the scope of the present invention. Components of a higher-order unit, e.g. an element, device, or assembly, that are indicated separately, can form separate components of this unit, or integral parts or sections thereof, even if the drawing indicates otherwise.

A preferred exemplary embodiment of the invention is shown in the drawing and shall be explained in greater detail below.

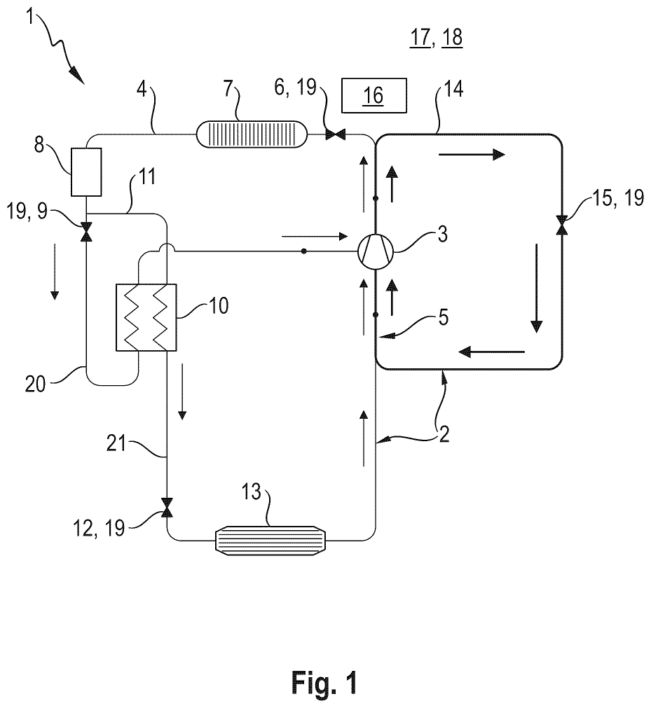

FIG. 1 shows one possible embodiment of the cooling unit obtained with the invention.

The cooling unit 1 shown in FIG. 1 contains a refrigerant circuit 2 that has a compressor 3 with a downstream high pressure section 4 and an upstream low pressure section 5. The direction in which the slightly inflammable refrigerant flows in the refrigerant circuit 2 is indicated by the arrows.

There is a shut-off device 19, specifically a magnetic valve 6, downstream of the compressor 3, and a condenser 7 downstream of the magnetic valve 6. There is a dehumidifier 8 downstream of the condenser 7, and a first expansion valve 9 downstream of the dehumidifier 8. There is a heat exchanger 10 between the first expansion valve 9 and the compressor 3, i.e. at the input end of the compressor 3, through which refrigerant exiting the first expansion valve 9 flows.

There is a first branch 11 between the dehumidifier 8 and the first expansion valve 9, which is connected to the input end of the compressor 3 through the heat exchanger 10 and a second expansion valve 12 downstream thereof, as well as a chiller 13 downstream of the second expansion valve 12.

Depending on the setting of the first expansion valve 9, the refrigerant flows to a greater or lesser extent through the first branch 11, the heat exchanger 10, the second expansion valve 12, and the chiller 13 to the compressor 3 and/or through the first expansion valve 9 and the heat exchanger 10 to the compressor 3. When a portion of the refrigerant flows through both the first expansion valve 9 and the first branch 11, heat from the expanded, and therefore cooler, refrigerant downstream of the first expansion valve 9 can be transferred through the first branch 11 to the pressurized refrigerant in the heat exchanger 10.

There can also be a second branch 14 between the compressor 3 and one of the shut-off devices 19, in this case the magnetic valve 6, which is connected to the input end of the compressor 3 by a third expansion valve 15.

The magnetic valve 6, first expansion valve 9, second expansion valve 12, and third expansion valve 15 are all examples of shut-off devices 19.

The refrigerant flowing through the refrigerant circuit 2 is a slightly inflammable refrigerant, e.g. R290 (propane), which has the major advantage that it has excellent thermodynamic properties and is extremely environmentally friendly. The only disadvantage with using R290 as a refrigerant is its slight inflammability.

This is why the cooling unit 1 has a computer 16 connected to at least two shut-off devices 19. This means that the computer 16 can open and close at least two shut-off devices 19. As FIG. 1 shows, the three shut-off devices 19, specifically the magnetic valve 6, first expansion valve 9, and second expansion valve 12, must be closed to separate two refrigerant circuit segments from one another, because refrigerant can still flow through the compressor 3 when the cooling unit is switched off. Only two shut-off devices 19, specifically the magnetic valve 6 and the second expansion valve 12, need to be closed in other cooling units 1 to divide the refrigerant circuit 2 into two segments.

The computer 16 is designed to execute a method for operating the cooling unit 1 containing the slightly inflammable refrigerant, which closes at least two of the shut-off devices 19, or three shut-off devices 19 in the case of the cooling unit 1 shown in FIG. 1, specifically the magnetic valve 6, first expansion valve 9, and second expansion valve 12, thus dividing the refrigerant circuit 2 into at least two separate refrigerant circuit segments when the cooling unit 1 is switched off.

By using R290 (propane) as the refrigerant, there is a relatively high potential for starting a fire, in particular in poorly ventilated spaces if the refrigerant leaks out of the refrigerant circuit 2. The method obtained with the invention is intended to reduce this risk in that the computer 16 closes at least two shut-off devices 19 when the cooling unit 1 is switched off. This is the case if there is no first segment 20 of the refrigerant circuit 2 from the first expansion valve 9 through the heat exchanger 10 to the compressor 3, and only a second segment 21 leads from the first branch 11 through the heat exchanger 10, second expansion valve 12 and the chiller 13 to the compressor 3. In this case, where there is also no first expansion valve 9 or heat exchanger 10, it is sufficient to close the second expansion valve 12 and the magnetic valve 6.

If the cooling unit 1 obtained with the invention, as shown in FIG. 1, has a total of four shut-off devices 19, specifically the magnetic valve 6, first expansion valve 9, second expansion valve 12, and third expansion valve 15, the computer 16 can close all of the shut-off devices 19, i.e. all of the valves 6, 9, 12, and 15, when the cooling unit 1 is switched off, such that the initially continuous refrigerant circuit 2 is divided into two separate segments, each of which then only contains a portion of the refrigerant from the entire refrigerant circuit 2, such that if there is a leak anywhere in the refrigerant circuit 2, only part of the refrigerant can escape into the environment, increasing the fire hazard.

If the compressor 3 is blocked when switched off, such that refrigerant cannot flow through it, the refrigerant circuit can be divided into even more segments.

The cooling unit 1 can be part of an air conditioner 17 in a motor vehicle 18, which can be an electric vehicle. When R290 is used as the refrigerant and the vehicle 18 is an electric vehicle, a particularly sustainable and safe motor vehicle 18 is obtained.

On the whole, the fire hazard can be significantly reduced with the method and the cooling unit obtained with the invention by dividing the entire refrigerant circuit 2 into individual segments, and the use of R290 as the refrigerant, or any refrigerant without fluorine or chlorine, is substantially more environmentally friendly.

The specification can be readily understood with reference to the following numbered Paragraphs:
Numbered Paragraph 1. A method for operating a cooling unit (1) that has a refrigerant circuit (2) containing slightly inflammable refrigerant and at least two shut-off devices (19) that can be controlled by a computer (16), in which the computer (16) closes the at least two shut-off devices (19) and thus divides the refrigerant circuit (2) into at least two separate segments when the cooling unit (1) is switched off.
Numbered paragraph 2. the method according to numbered paragraph 1, characterized in that
   there are at least three shut-off devices (19), at least one of which is an expansion valve (9, 12, 15) or a magnetic valve (6), and
   the computer (16) closes the at least three shut-off devices (19) when the cooling unit (1) is switched off.
Numbered Paragraph 3. A cooling unit (1) that has
   a refrigerant circuit (2) containing a slightly inflammable refrigerant,
   at least two shut-off devices (19) that can be opened and closed,
   a computer (16) connected to the at least two shut-off devices (19), designed to execute the method according to Numbered Paragraph 1 or 2.
Numbered Paragraph 4. the cooling unit (1) according to numbered Paragraph 3,characterized in that
   there is a compressor (3) in the refrigerant circuit (2), a shut-off device (19) in the form of a magnetic valve (6) downstream thereof, a condenser (7) downstream of the magnetic valve (6), a dehumidifier (8) downstream of the condenser (7), a shut-off device (19) in the form of a first expansion valve (9) downstream of the dehumidifier (8), and a heat exchanger (10) between the first expansion valve (9) and the compressor (3), and
   there is a first branch (11) between the dehumidifier (8) and the first expansion valve (9) that is connected to the input end of the compressor (3) by the heat exchanger (10) and a shut-off device (19) in the form of a second expansion valve (12) downstream of the heat exchanger (10), and a chiller (13) downstream of the second expansion valve (12).
Numbered Paragraph 5. The cooling unit (1) according to Numbered Paragraph 4, characterized in that the computer (16) is designed to close the first expansion valve (9), second expansion valve (12) and magnetic valve (6) when the cooling unit (1) is switched off.
Numbered Paragraph 6. The cooling unit (1) according to Numbered Paragraph 4 or 5, characterized in that there is a second branch (14) between the compressor (3) and the magnetic valve (6) that is connected to the input end of the compressor (3) by a third expansion valve (15) forming a shut-off device (19).
Numbered Paragraph 7. The cooling unit (1) according to Numbered Paragraph 6, characterized in that the computer (16) is designed to close the first expansion valve (9), second expansion valve (12) and magnetic valve (6) when the cooling unit (1) is switched off.
Numbered Paragraph 8. The cooling unit (1) according to any of the Numbered Paragraphs 3 to 7, characterized in that the refrigerant is R290 (propane). Numbered Paragraph 9. An air conditioner (17) that has a cooling unit (1) according to any of the Numbered Paragraphs 3 to 8.
Numbered Paragraph 10. A motor vehicle (18) that has an air conditioner (17) according to Numbered Paragraph 9.
Numbered Paragraph 11. The motor vehicle (18) according to Numbered Paragraph 10, characterized in that the motor vehicle (18) is an electric vehicle.

### LIST OF REFERENCE SYMBOLS

1 cooling unit
2 refrigerant circuit
3 compressor
4 high pressure section
5 low pressure section
6 magnetic valve
7 condenser
8 dehumidifier
9 first expansion valve
10 heat exchanger
11 first branch
12 second expansion valve
13 chiller
14 second branch
15 third expansion valve
16 computer
17 air conditioner
18 motor vehicle
19 shut-off device
20 first segment
21 second segment

1-11. (canceled)

12. A method for operating a cooling unit that has a refrigerant circuit containing slightly inflammable refrigerant and at least two shut-off devices that can be controlled by a computer, comprising the computer closing the at least two shut-off devices and thus dividing the refrigerant circuit into at least two separate segments when the cooling unit is switched off.

13. The method according to claim 12, further comprising
at least three shut-off devices, at least one of which is an expansion valve or a magnetic valve, and
the computer closing the at least three shut-off devices when the cooling unit is switched off.

14. A cooling unit comprising
a refrigerant circuit containing a slightly inflammable refrigerant,
at least two shut-off devices that can be opened and closed,
a computer connected to the at least two shut-off devices, the computer configured to execute the method according to claim 12.

15. The cooling unit according to claim 14, further comprising
a compressor in the refrigerant circuit, a shut-off device downstream of the
compressor, wherein the shut-off device is a magnetic valve, a condenser downstream of the magnetic valve, a dehumidifier downstream of the condenser, a shut-off device downstream of the dehumidifier, wherein the shut-off device is a first expansion valve, and a heat exchanger disposed between the first expansion valve and the compressor, and
further comprising a first branch between the dehumidifier and the first expansion valve that is connected to the input end of the compressor by the heat exchanger and a shut-off device downstream of the heat exchanger, wherein the shut-off device is a second expansion valve, and a chiller downstream of the second expansion valve.

16. The cooling unit according to claim 15, wherein the computer is configured to close the first expansion valve, second expansion valve and magnetic valve when the cooling unit is switched off.

17. The cooling unit according to claim 15, further comprising a second branch between the compressor and the magnetic valve, wherein the second branch is connected to the input end of the compressor by a third expansion valve forming a shut-off device.

18. The cooling unit according to claim 17, wherein the computer is configured to close the first expansion valve, second expansion valve and magnetic valve when the cooling unit is switched off.

19. The cooling unit according to claim 14, wherein the refrigerant is R290 (propane).

20. An air conditioner comprising that has a cooling unit according to claim 14.

21. A motor vehicle comprising an air conditioner according to claim 20.

22. The motor vehicle according to claim 21, wherein the motor vehicle is an electric vehicle.
